(19) United States
(12) Patent Application Publication
(10) Pub. No.: US 2011/0151049 A1
(43) Pub. Date: Jun. 23, 2011

(54) Device at a Collapsible Core, Preferably at Injection-Moulding Tool for Plastic Material, Silicone, Rubber and Similar Material

(76) Inventor: Hans Müller, Frufällen (SE)

(21) Appl. No.: 12/447,267

(22) PCT Filed: Oct. 31, 2007
(86) PCT No.: PCT/SE2007/050800

§ 371 Date: Apr. 27, 2009

Related U.S. Application Data
(60) Provisional application No. 60/856,203, filed on Nov. 2, 2006.

(30) Foreign Application Priority Data
Nov. 1, 2006 (SE) 0602312-1

(51) Int. Cl. B29C 33/48; B29C 45/44

(52) U.S. Cl. 425/577

(57) ABSTRACT

The invention relates to a device (1) at a collapsible core (2) for a plastic-injection-moulding machine (3) for plastic and where the core (2) has a plurality of segments (4, 5) that in an interconnected state (I) form an inner core (2) of the mould (6), and that an axially movable (8) central pin (9) is received centrally (7) in the core (2). According to the invention, the segments (4, 5) are separated from each other as well as from the central pin (9) and are securingly received pivot ably mounted in a movable ejector pin plate (22).

The present invention relates to a device at a collapsible core for an injection-moulding tool and where the core has a plurality of segments that in an interconnected state form an inner core of the mould, and that an axially movable central pin is received centrally in the core.

A collapsible core is primarily used to be able to expose undercuts, such as e.g., threads or grooves, in an injection-moulded plastic article or of a similar material. For a quick injection-moulding cycle, such collapsible cores have many advantages since it is not needed to wait for a rotating core being entirely unscrewed. Furthermore, neither is it needed to form threads all the way out on the object in question that is manufactured. If the unscrewing is run fast, heat is generated that may damage the plastic. For sturdy undercuts where the plastic article is not elastic enough to be pulled off easily, collapsed cores are also used. In most cases, the tool has a plurality of mould cavities, and collapsed cores have been available on the market for a long time, approx. 25-30 years. The basic principle of these cores is that the intermediate portion stands still while the forming sleeve is displaced forward. Half the number of segments then quickly fall inward while the remaining ones follow afterward. Then the plastic article is ejected by an ejector pin plate that lifts with a separate motion in the tool.

However, most known embodiments bend the different segments and press them back again by means of the central pin. See, for instance, U.S. Pat. No. 3,247,548 A and U.S. Pat. No. 3,660,001 A. A substantial disadvantage thereby is that the accessibility between the parts is difficult to achieve, e.g., in order to finish the parts, both to improve the strength and the surface finish.

Another known system is that a collapsible core consists of parts that by means of dovetail slots are kept together. These are brought forward at different angles so that the core collapses. A major drawback of the same is that the collapsing distance becomes substantially shorter. Also, the manufacturing costs are much too high.

Therefore, the main object of the present invention is primarily to solve, among other things, the problems mentioned above in an efficient, reliable and cost-advantageous way.

Said object is attained by means of a device according to the present invention that essentially is characterized in that the segments are separated from each other as well as from the central pin and are securingly received pivotably mounted in a movable ejector pin plate as well as are spring-force actuated in order to normally assume the turned-out core-shaped states thereof, in a substantially straight shape without the segments needing to be bent, and, respectively, that essentially is characterized in that the collapsible core, which is made in one or a partable piece, and where the central pin has a substantially uniform diameter along the internally active length thereof between the segments of the core, is arranged to be actuated by a sleeve that is situated externally of the core and, via a number of conical notches, arranged to co-operate with mating conical stoppers on the core to cause the same to spring together upon displacement in relation to each other.

The new embodiments according to the present invention are arranged so that they operate in an entirely new and superior way. Thanks to the different segments being movably attached and moving as a hinge, the same need not to be bent when the core collapses. Neither is it no longer necessary to use spring steel. Neither is it now needed to adapt the hardness to resilient properties, which entails that the durability increases.

An advantage of loose segments is that the accessibility increases between the segments in respect of being able to improve the surface finish, which is advantageous.

Since the segments according to the invention are brought back and are placed straight before the central pin slides in between the segments, the wear is minimized.

Since the function now only demands minimal forces, also the total wear is minimal and therefore a two-stage ejector can be used to eject the plastic article and lift the ejector pin plate.

The invention is described below in the form of a number of preferred embodiment examples, reference being made to the accompanying drawings, in which

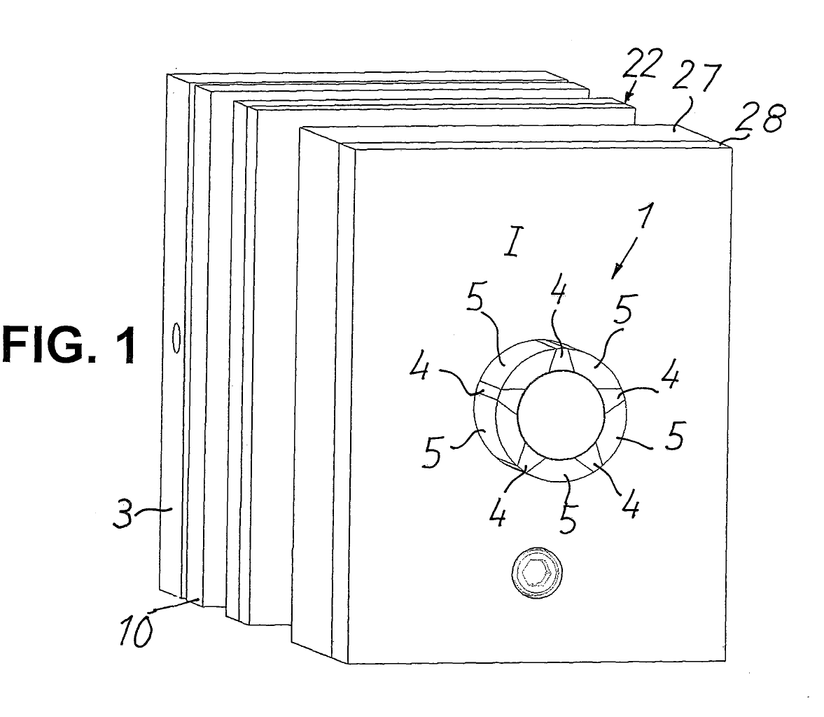

FIGS. 1-16 show a first embodiment example, where

FIG. 1 shows in perspective example of an injection-moulding tool as seen obliquely from the front in an initial position for the opening of the mould core thereof,

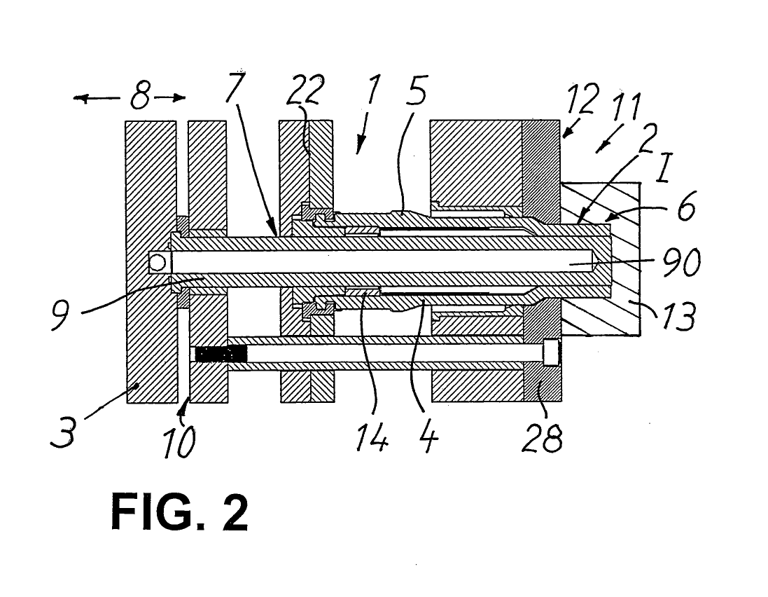

FIG. 2 shows a cross-section view of said injection-moulding tool,

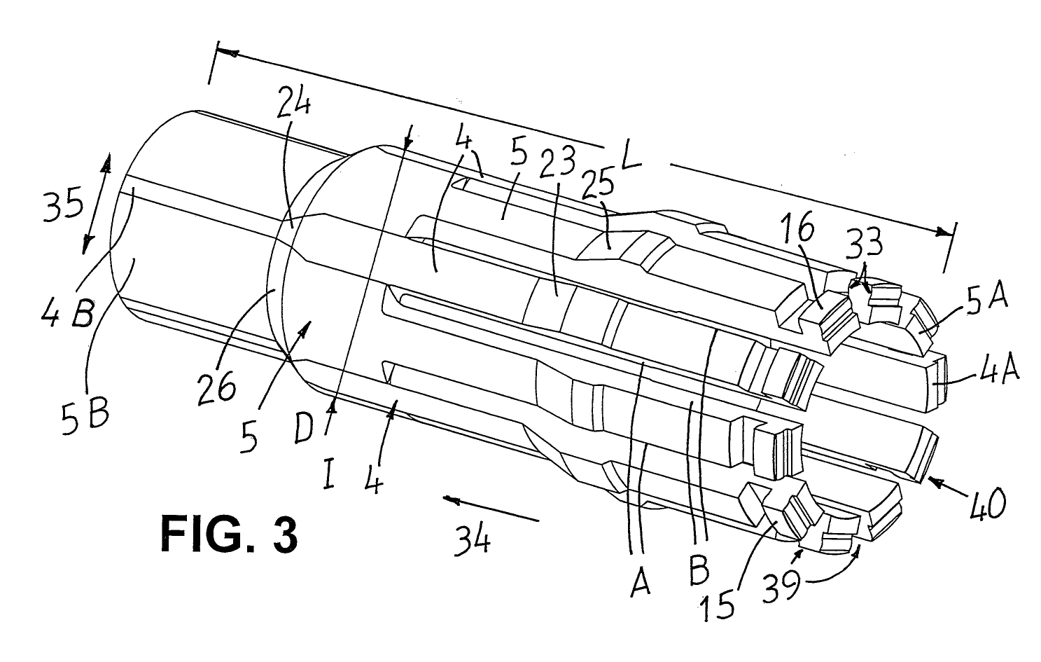

FIG. 3 shows the proper tool core in perspective and in a tightened-together state,

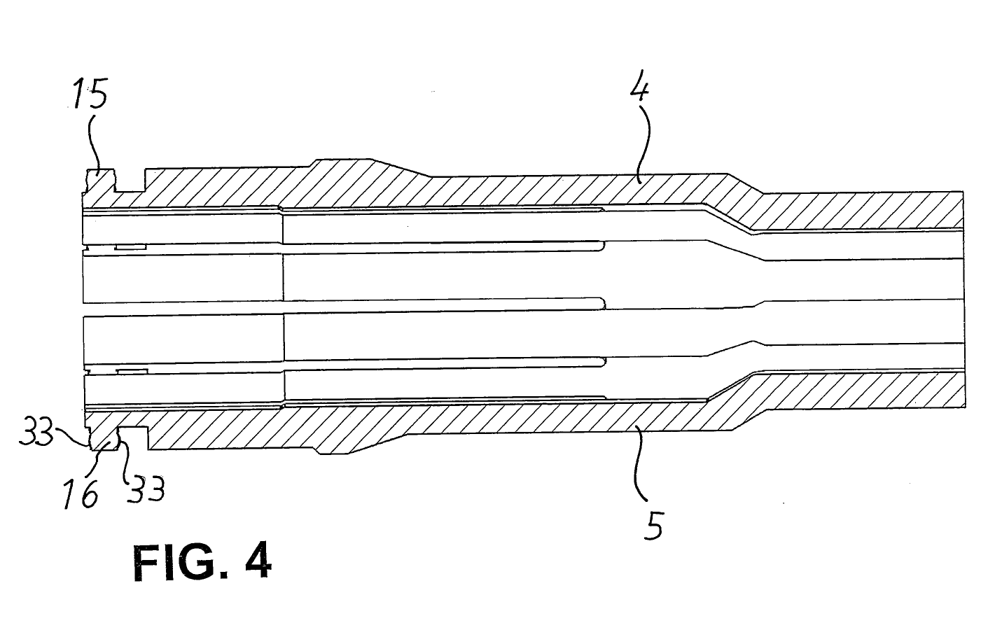

FIG. 4 shows a cross-section view of the tool,

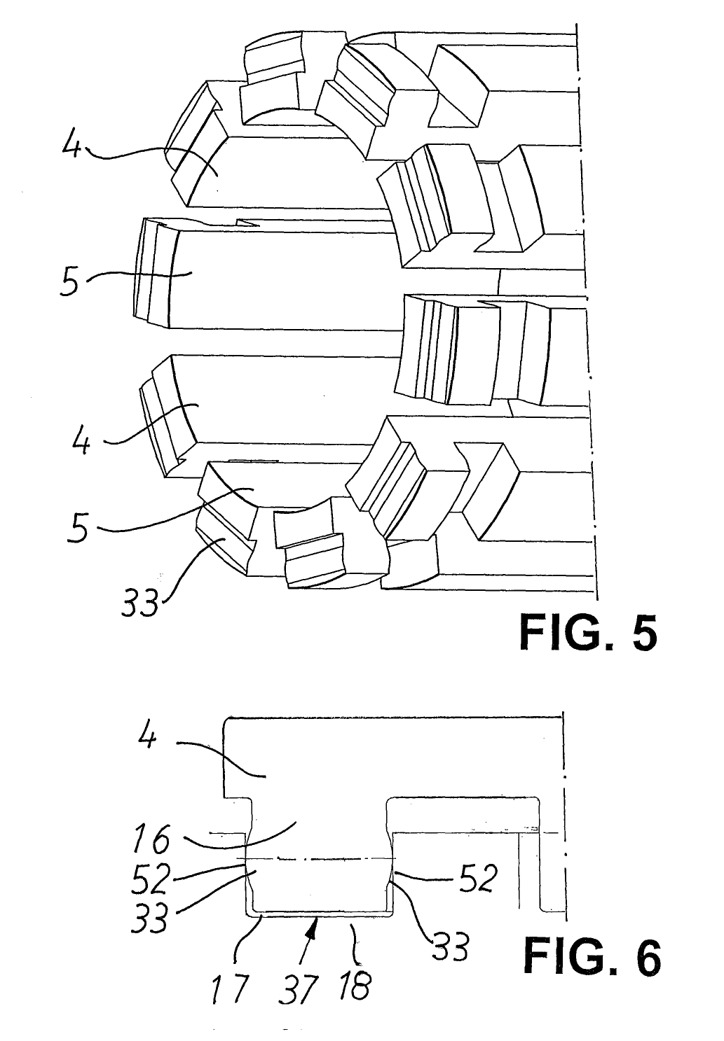

FIG. 5 shows the rear portion of said tool,

FIG. 6 shows a segment of the tool in a storage state,

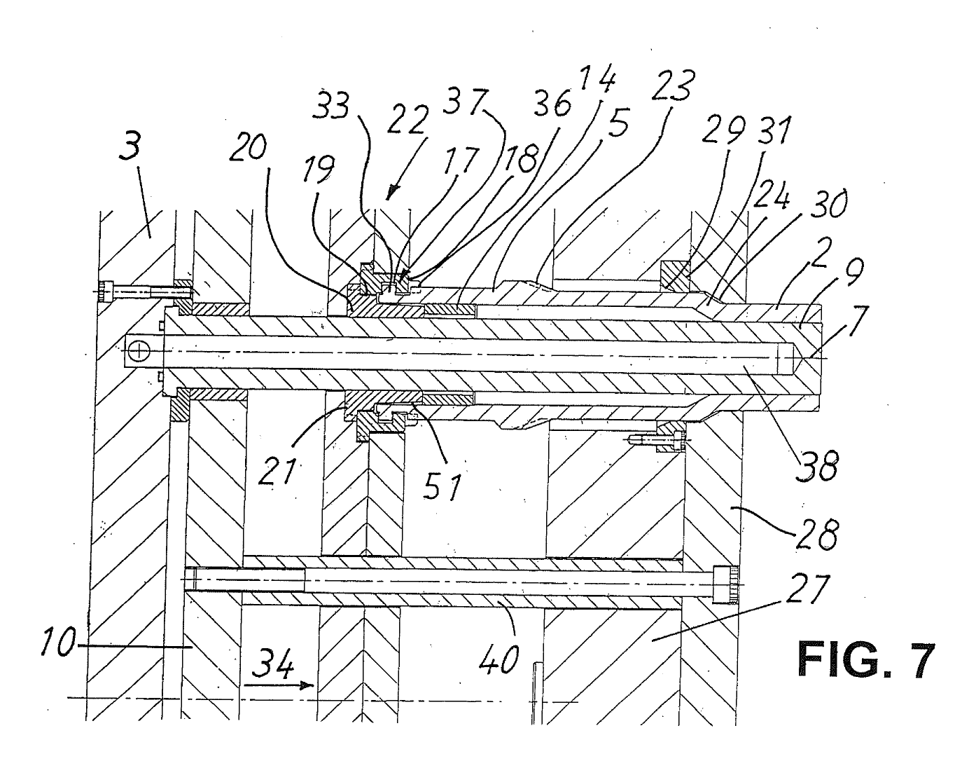

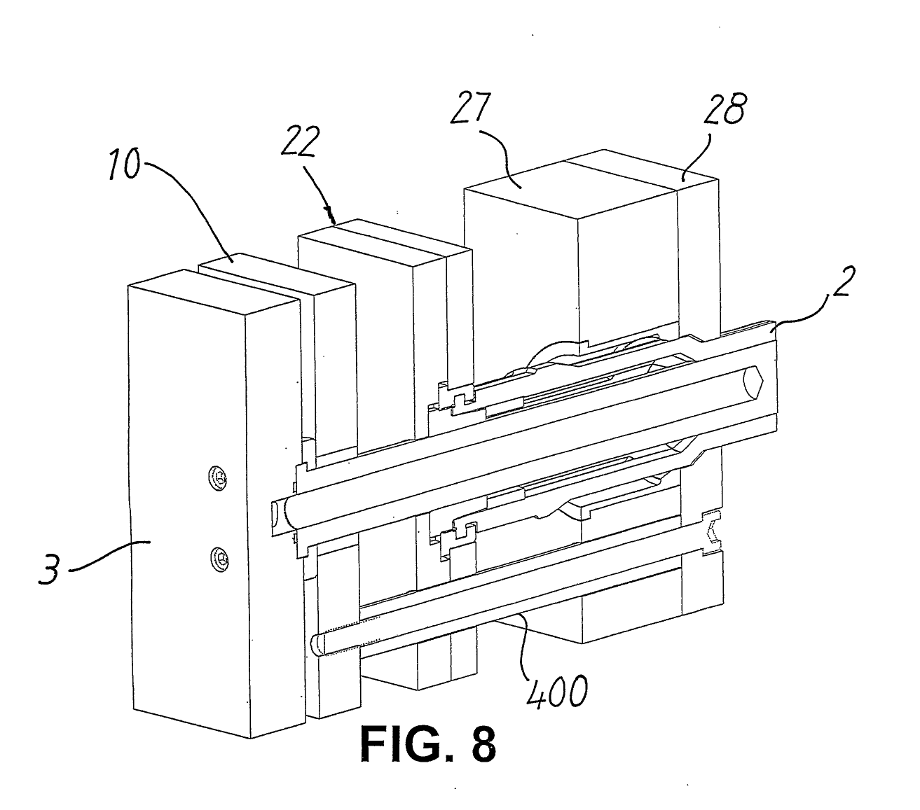

FIGS. 7-8 show additional section views of the tool,

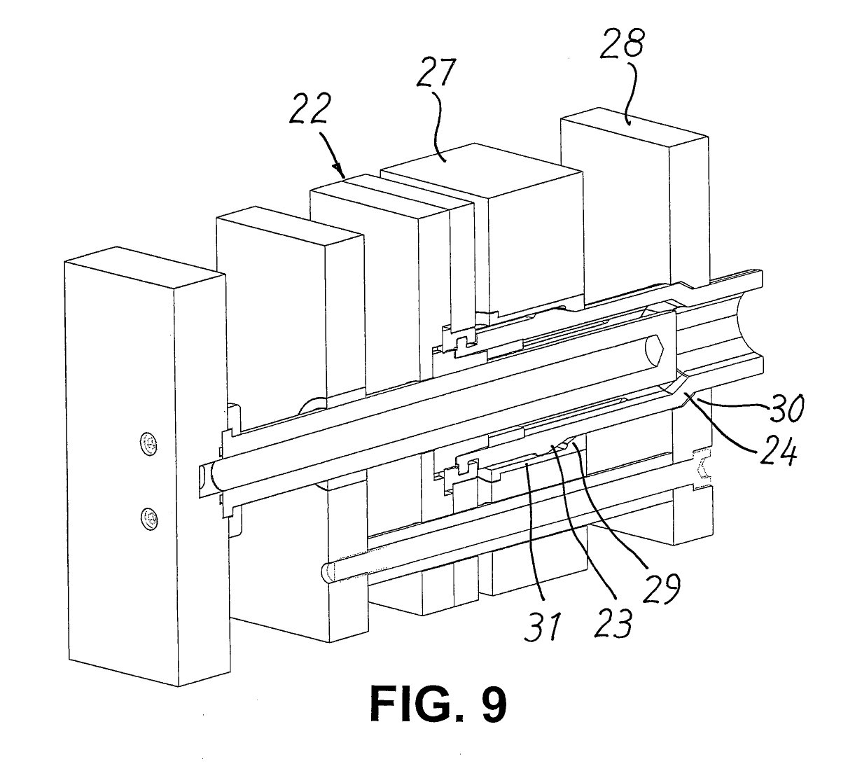

FIG. 9 shows in perspective and in section the tool in an initially collapsing state,

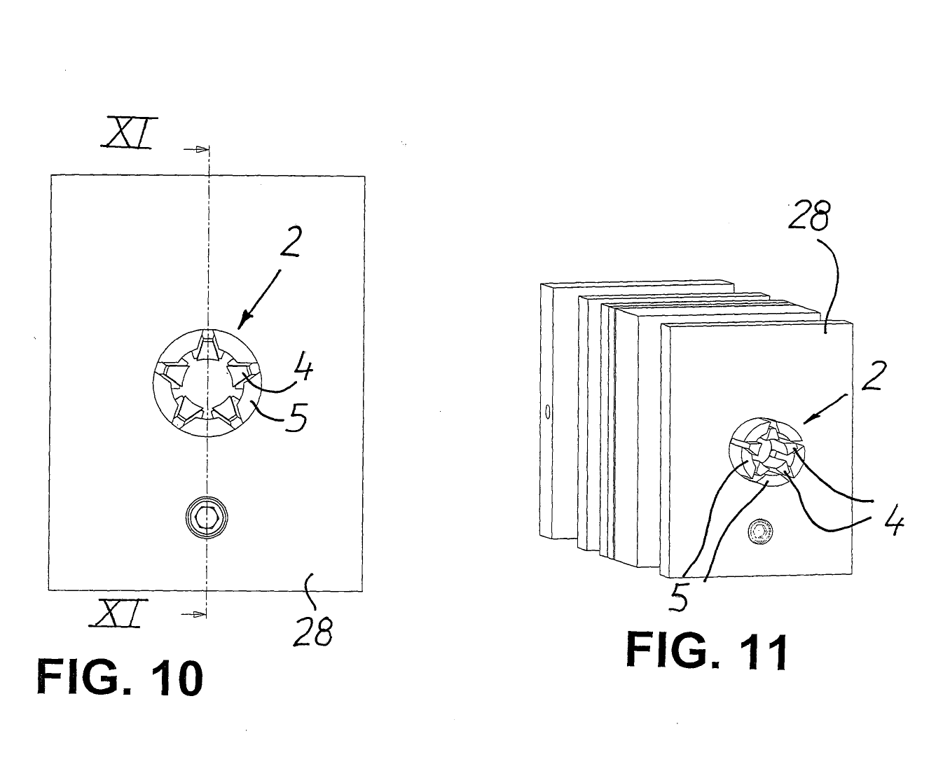

FIGS. 10 and 11 show additional views of the tool in the collapsing state thereof,

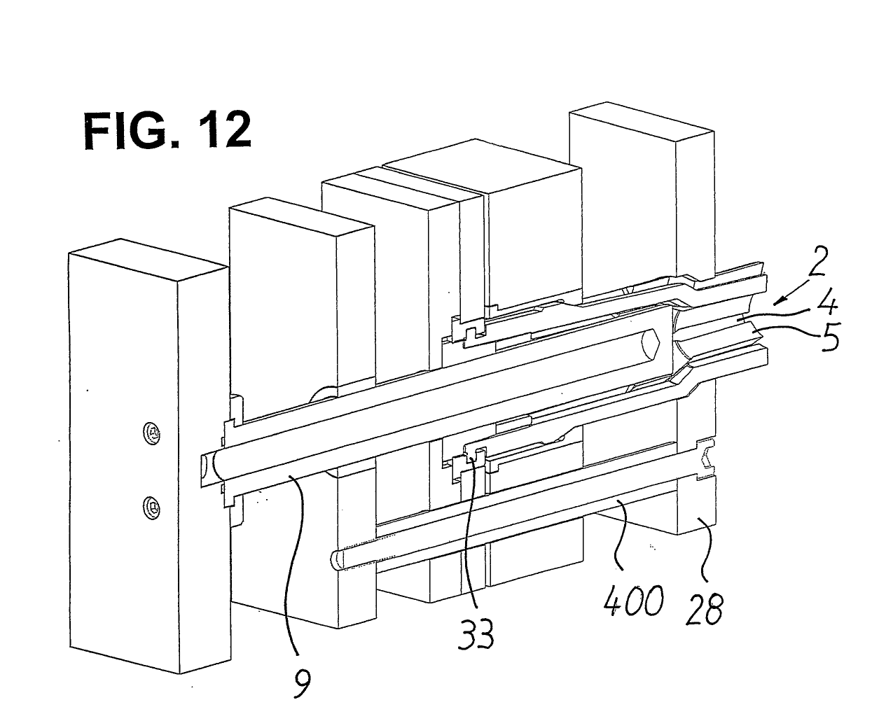

FIG. 12 shows a continued state of the collapse of the core,

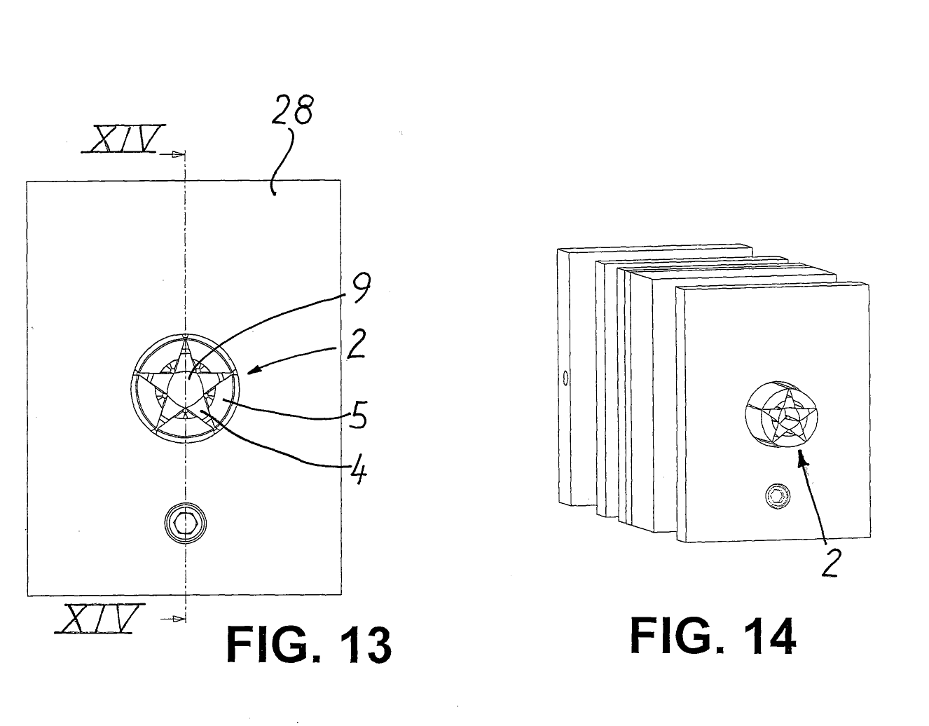

FIGS. 13 and 14 show views of the tool with the core collapsed, and

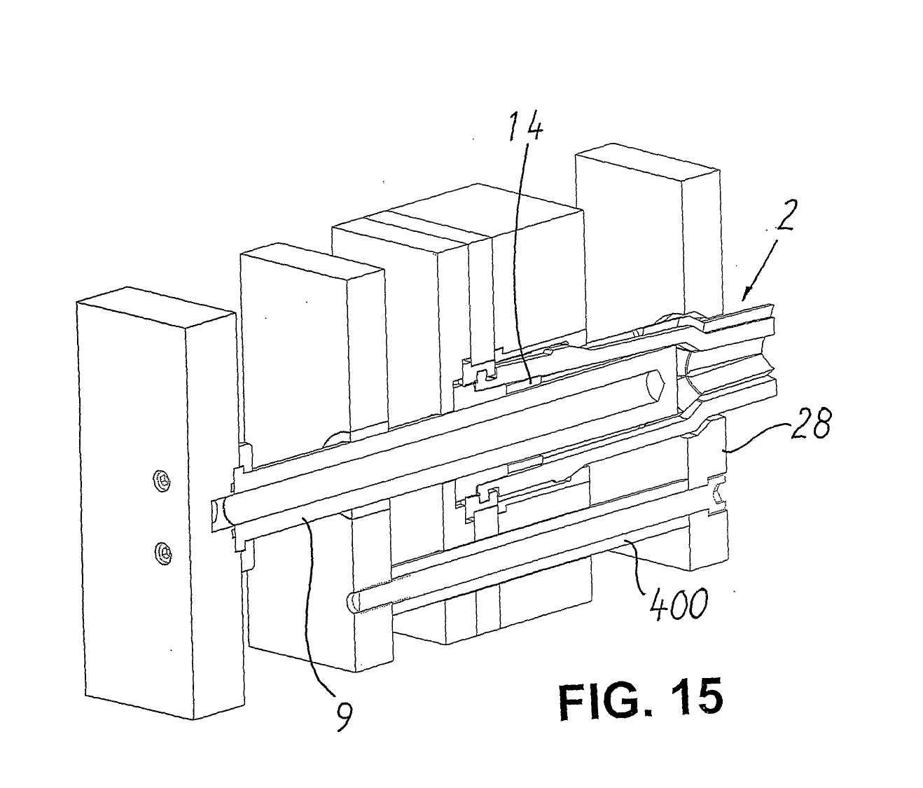

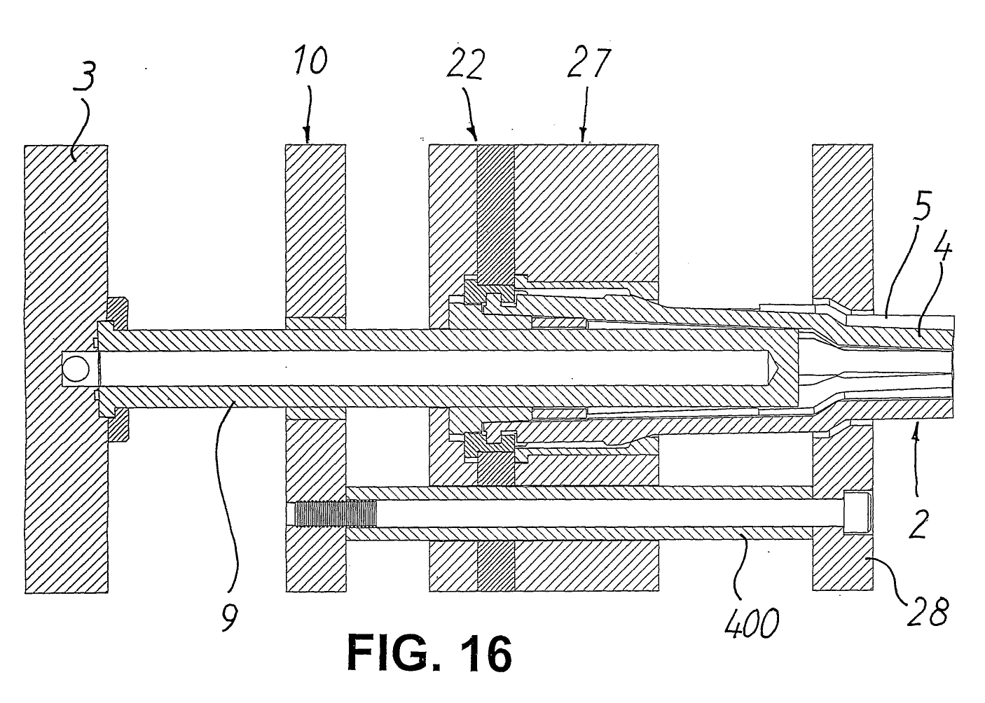

FIGS. 15-16 finally show in perspective and section, respectively, the tool with the core entirely collapsed,

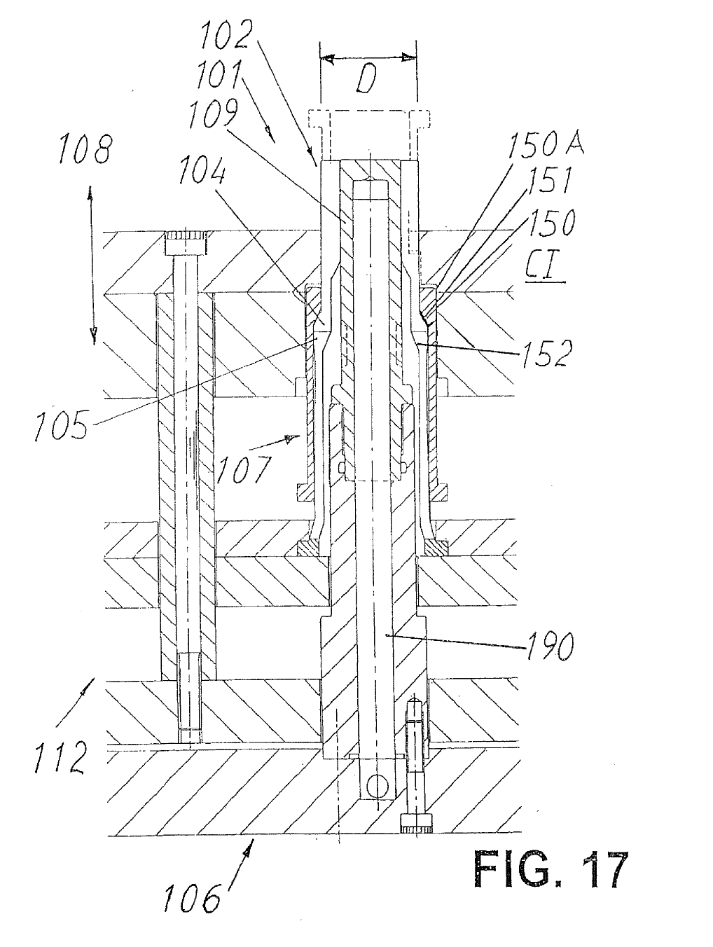

FIG. 17 shows a second embodiment example schematically in section view,

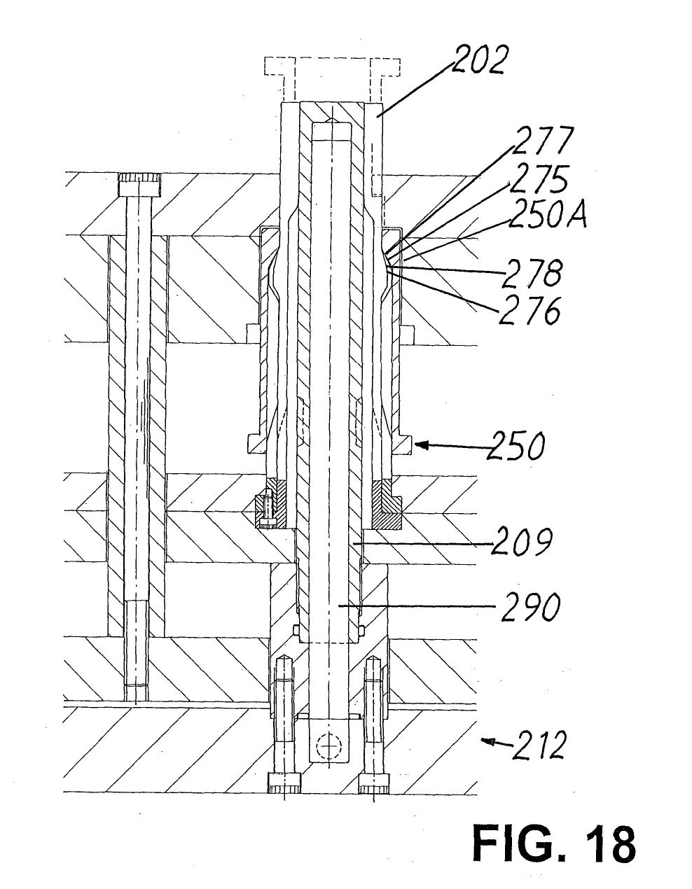

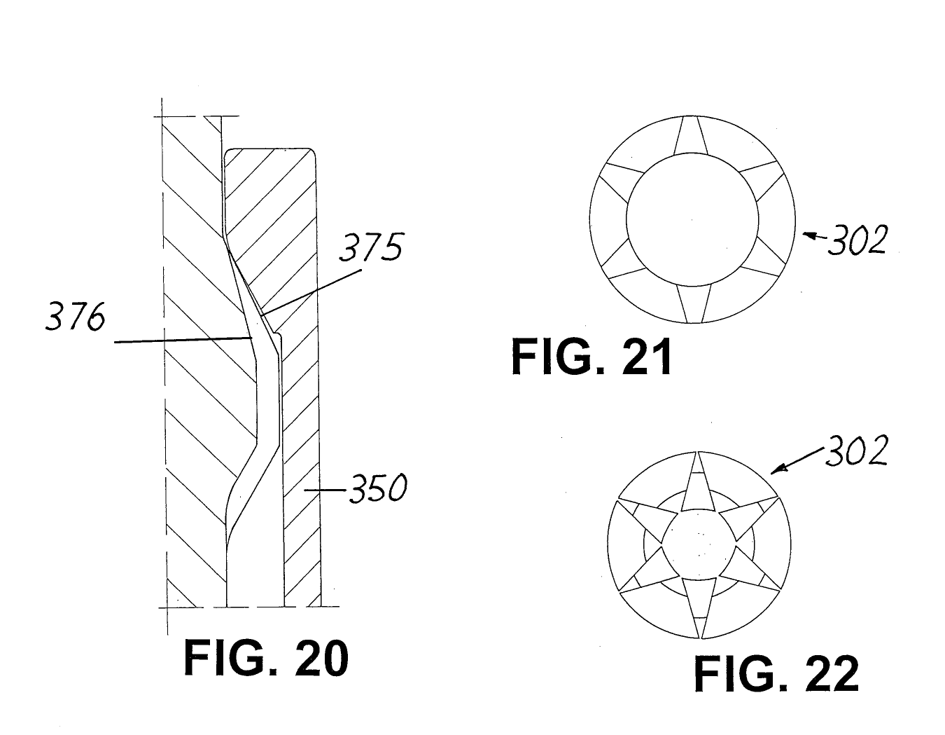

FIGS. 18 and 20 show a third embodiment example,

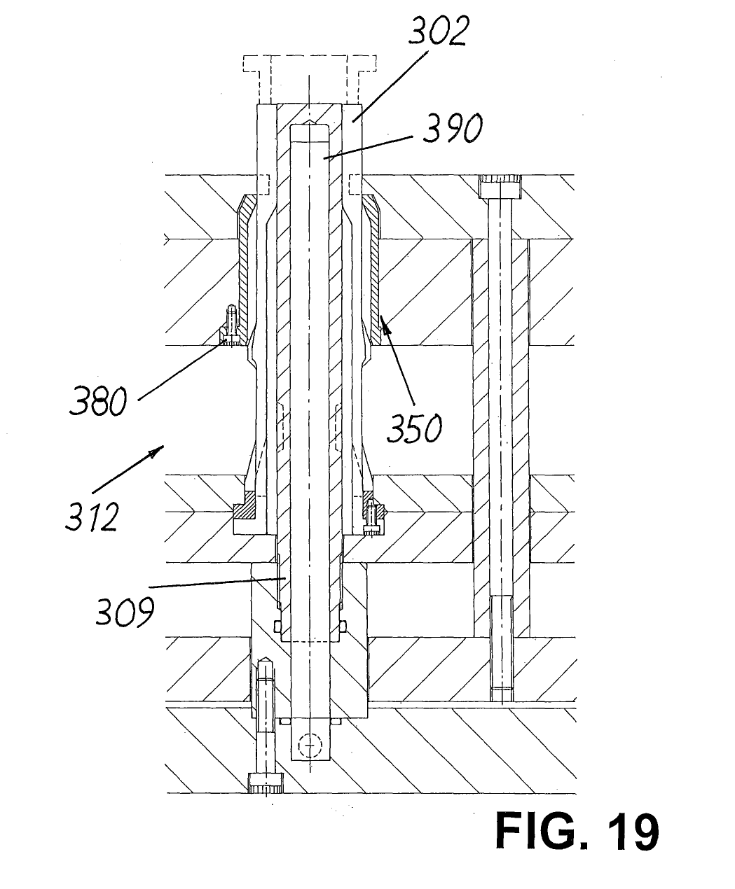

FIG. 19 shows a fourth embodiment example, and

FIGS. 21-22 show cross-sections of the core in an interconnected state and in a brought-apart state, respectively.

A device 1 at a collapsible core 2 that is arranged to be used at an injection-moulding tool 3 for plastic and where the core 2 has a plurality of movable segments 4, 5 that in an interconnected state I, i.e., compressed state, form an inner core 2 for the inner mould 6 in question on the forming plastic article 13 that is injection moulded in the moulding tool 12, and that an axially movable 8 central pin 9 is received centrally 7 in the core 2 and the tool 12 has the segments 4, 5 separated from each other as well as from the central pin 9. In addition, the segments 4, 5 are securingly received in the tool 12 pivotably mounted in a movable ejector pin plate 22. As is seen in the drawings, among others in FIGS. 2 and 3, the core 2 has a substantially uniform diameter D along the entire length L thereof, as seen when the core 2 is in a retracted and interconnected state I prepared for moulding.

Said central pin 9, which is arranged to widen the segments 4, 5 to assume a state of forming a core in front 11 in the tool 12 and to form an inner part upon injection moulding of the intended plastic product 13 thereon, which is shown schematically in FIG. 2, is attached to a fixed rear plate 3.

Otherwise, the segments 4, 5 are arranged to be spring-force actuated in order to normally assume the turned-out core-shaped states thereof by the action of a ring 14 situated internally thereof of a resilient material, preferably polyurethane plastic and that is received internally of said segments 4, 5 brought together into a ring shape.

Furthermore, the segments 4, 5 have a respective foot 15, 16 that is flange-shaped and arranged to be received internally in a chute-shaped reception part 17 of a surrounding mounting ring 18, which via threaded joints 19 is bolted to a centring ring 20 movable on the central pin 9. Suitably, the mounting ring 18 and the centring ring 20 are received internally in a hollow space 21 in a said movable ejector pin plate 22.

Said segments 4, 5 have external leaning stop faces 23 and 25, respectively, which are arranged to be co-operatable with a tool plate 27 and, respectively, an ejector pin plate 28 and its preferably oblique stop face 29. A hardened sleeve 31 that has an inner conical stop part 29, may be received internally in said fixedly standing tool plate 27. An oblique surface 30 of the ejector pin plate 28 allows clearance for the segments 4, 5 and the external leaning oblique surfaces 24, 26 thereof.

The mounting of the segments 4, 5 is provided by an arched convexly vaulted mounting part 33 of the rear portion 4A, 5A of the respective segment, as seen in the working direction 34 of the tool, being received in a radial turned-in straight groove 17. The respective segment 4, 5 is received guided laterally 35 by a lateral guide 36 situated on each side A, B of the respective segment 4, 5 at the area in front of the mounting 37 thereof, as seen in the working direction 34 of the tool.

The function and the nature of the invention should have been understood from what has been mentioned above and the numerous drawings.

In FIG. 6, the mounting 37 of the respective segment 4, 5 is clearly seen, and in FIG. 16, there is clearly seen how said core 2 has collapsed when the axially displaceable central pin 9, which in the interior thereof has a not fully through axial bore 38 for throughput of cooling liquid 90, preferably water or another fluid. As interconnected side by side in the front end 4B, 5B thereof, the segments 4, 5, which preferably have different width, form a closed core 2 along the circumference thereof, while they in the rear end 4A, 5A thereof forms a ring 40 having interruptions 39 thembetween.

Following the drawings, the function of the device 1 is realized. The various tool plates 10, 22, 27, 28 co-operate with the core 2 with the outer plate 28 constituting a stripper plate that presses out the injection-moulded plastic article 13 after the solidification thereof, and that is attached to the rear plate 10 via a rod 400.

When the plate 22 is pushed out in the direction 34 and the core 2, in this state, is formed by the straight-positioned segments 4, 5, said oblique portions 23 and 25, respectively, of the segments 4, 5 are actuated by co-operation with the stopper 29 of the tool plate 27 so that the segments 4, 5 are actuated to be turned around the pivot joint 37 and the arc-shaped vaulted convex mounting surface 33 thereof while abutting against the preferably straight mounting surface 52 of the mounting, so that the core- and mould-forming ends 4B, 5B of the segments are turned inward toward the centre 7 of the core 2 and the central pin 9, such as is shown in FIGS. 12, 15 and 16.

By the fact that the centring ring 20 has a leaning portion 51, which leans in the forward direction 34, as seen in the normal injection and working direction of the tool and along the outer envelope surface thereof, the inward leaning of the segments 4, 5 is maximized when the central pin 9 is pulled out of the forming core 2.

The embodiment according to FIG. 17, which comprises a device 101 at a collapsible core 102 for an injection-moulding tool 112 and where the core 102 has a plurality of segments 104, 105 that in the interconnected state CI form an inner core 102 of the mould 106, and where an axially movable 108 central pin 109 is received centrally 107 in the core 102, has the collapsed core made either in one or a partable piece. In that connection, the central pin 109 has a substantially uniform diameter D along the internally effective length thereof between the segments 104, 105 of the core. Said core 102 is arranged to be actuated by a sleeve 150 that is situated externally of the core 102 and, via a number of conical notches 151, arranged to co-operate with mating conical stoppers 152 on the core 102 to cause the core 102 to spring together upon displacement of the core 102 and the sleeve 150 in relation to each other.

Said sleeve 150 is loosely arranged in the tool 112 and has an inner conical notch 151 at one end 150A of the sleeve 150. Furthermore, the collapsed core 102 is made in a single piece by, e.g., wire sparking, and that it is arranged to assume a straight shape in an unaffected state. In this embodiment, the collapsible core 102 is made in one piece. The sleeve is opened by, for example, wire sparking, into partly thin and wider conical segments. The difference between the cores on the market already known and the present embodiment is that the central pin does not need to push apart the collapsible segments, and therefore heavy wear on the front edge is prevented. Accordingly, the present segments stand straight up when the pin is to return between the segments. The advantage is that the pin does not need to be conical. This facilitates the manufacture and the delivery of spare-parts of a certain cylindrical dimension.

The fixing part (the foot) of the collapsible core 102 has a short cone that after the heating and by means of a pre-pressing sleeve is pressed axially on the cone to forge together the small gaps after the wire sparking. The external loose sleeve and the inner cone thereof were used because the segments collapse in two different steps.

The embodiment according to FIG. 18 is similar to the one described above and shown in FIG. 17. However, in that connection, the sleeve 250 is formed of two parts and it is loosely arranged in the tool 212. Furthermore, it has pairwise conical notches 275, 276 at one end 250A of the sleeve 250 and are arranged to co-operate with a respective external stopper 277, 278 on the core 202.

By the fact that the collapsible core 102 consists of two parts, it means that the two parts can be manufactured separately. The parts may be fitted in each other via milled openings. The advantage consists of the fact that the diameters internally and externally can be machined to the final dimension before mounting. Thereby, heat treatment is not required to press together possible wire-sparking grooves.

The embodiment according to FIG. 20 differs from the others in that the sleeve 350 is bolted to the tool 312 by means of a screw 380 and said sleeve 350 is also formed of two parts.

The difference is that the loose external sleeve has been replaced by a bolted sleeve. This means that the cone, which produces the collapse, is situated axially further from the mould. This is a slight drawback for embodiments having fixed sleeves.

In that connection, front conical notches 375, 376 are arranged to push in segments of the core 302 in two steps. The cone 376 pushes in wide segments while the cone 375 pushes in thin segments. The cone is chosen so that the segments keep metallic contact with each other. The thin ones with the wide ones while they are bent in or collapse, i.e., are bent together.

Common to all embodiment examples is that internally in the central pin 9; 109; 209; 309, which may be in one piece or divided, there is a channel 90; 190; 290; 390 or another space intended for the receipt of cooling medium therein for cooling of the core and the tool.

The hook puller can be fitted in straight reamed bores without shoulder. Said bores may be pilot drilled through a plurality of plates simultaneously. In such a way, the highest accuracy is guaranteed as for the position of the hook puller.

The invention makes it possible to achieve the advantages previously mentioned in a simple and efficient way and by a tool that works reliably and efficiently.

Naturally, the invention is not limited to the embodiments described above and shown in the accompanying drawings. Modifications are feasible, particularly as for the nature of the different parts, or by usage of equivalent technique, without deviating from the scope of protection of the invention, such as it is defined in the claims. Thus, the tool may be used for other materials than plastic. For instance, silicone, rubber and other similar injectable materials can be used.

1-18. (canceled)

19. A device at a collapsible core for an injection-molding tool, the collapsible core having a plurality of segments that in an interconnect state form an inner core of the mold and an axially movable central pin received centrally in the core; wherein the collapsible core, which has the central pin in a substantially uniform diameter along an internally active length thereof between the segments of the core, is arranged to be actuated by a sleeve that is situated externally of the core, and via a number of conical notches, is arranged to co-operate with mating conical stoppers on the core that are arranged to push in segments of the core in two steps to cause the same to spring together upon displacement in relation to each other; and the device has front conical notches arranged to push in segments of the core in two steps, a first group of the front conical notches pushing in wide segments while a second group of the front conical notches pushes in thin segments, and the conical shapes of the groups of front conical notches are chosen such that the segments keep metallic contact with each other.

20. The device of claim 19, wherein the sleeve is loosely arranged in the tool and has an inner conical notch at one end thereof.

21. The device of claim 20, wherein the collapsible core is made in a single piece and is arranged to assume a straight shape in an unaffected state.

22. The device of claim 19, wherein the sleeve is formed of two parts, is loosely arranged in the tool, and has pair-wise conical notches at one end thereof arranged to co-operate with respective external conical stoppers on the core.

23. The device of claim 19, wherein the sleeve is bolted to the tool and is formed of two parts.
